(19) United States
(12) Patent Application Publication
(10) Pub. No.: US 2022/0036404 A1
(43) Pub. Date: Feb. 3, 2022

(54) BLOCK-BASED METHOD FOR REAL EVENT OBJECT EXCHANGE

(71) Applicant: BUCHIGO INC., Seoul (KR)

(72) Inventors: Moon-sung CHOI, Gyeonggi-do (KR); Young-kwan KIM, Chungcheongnam-do (KR); Dong-hyuk KIM, Gyeonggi-do (KR)

(21) Appl. No.: 17/298,846

(22) PCT Filed: Nov. 29, 2019
(86) PCT No.: PCT/KR2019/016732

§ 371 Date: Jun. 1, 2021

(30) Foreign Application Priority Data
Nov. 30, 2018 (KR) 10-2018-0152406
Nov. 20, 2019 (KR) 10-2019-0149715

(51) Int. Cl. G06Q 30/02; H04W 4/029; G06Q 20/36

(52) U.S. Cl. CPC G06Q 30/0253; G06Q 20/36; H04W 4/029; G06Q 30/0261

(57) ABSTRACT

A block-based method for an real event objects according to an embodiment of the present invention includes inputting registration information of character twins and a plurality of character blocks, generating the plurality of character blocks and a plurality of character block tokens corresponding to the plurality of character blocks in a one-to-one manner, executing an advertisement event that allows for collecting the generated character blocks and character block tokens and generating a magic key and character twin tokens corresponding to the character twins in a one-to-one manner, and ending the advertisement event according to an end condition of the advertisement event and then performing compensation for a selected compensation target consumer.

### CROSS REFERENCE TO RELATED APPLICATIONS AND CLAIM OF PRIORITY

This application claims benefit under 35 U.S.C. 119(e), 120, 121, or 365(c), and is a National Stage entry from International Application No. PCT/KR2019/016732, filed Nov. 29, 2019, which claims priority to the benefit of Korean Patent Application Nos. 10-2018-0152406 filed on Nov. 30, 2018 and 10-2019-0149715 filed on Nov. 20, 2019 filed in the Korean Intellectual Property Office, the entire contents of which are incorporated herein by reference.

### BACKGROUND

### 1. Technical Field

The present invention relates to a blockchain technology.

### 2. Background Art

In general, a method of providing, to a consumer terminal, compensation service according to the playback of media contents is present in the related art. However, a method of providing compensation service on the basis of blockchain has not been specifically proposed.

### SUMMARY

The present invention is to provide a block-based method for real event object exchange.

The block-based method for real event object exchange according to the present invention includes a first step of inputting registration information of character twins and a plurality of character blocks; a second step of generating the plurality of character blocks and a plurality of character block tokens corresponding to the plurality of character blocks in a one-to-one manner; a third step of executing an advertisement event that allows for collecting the generated character blocks and character block tokens and generating a magic key and character twin tokens corresponding to the character twins in a one-to-one manner; and a fourth step of ending the advertisement event according to an end condition of the advertisement event and then performing compensation for a selected compensation target consumer.

In addition, the block-based method for real event object exchange according to the present invention includes inputting the real event object corresponding to the character twin in a one-to-one manner from the advertiser terminal to the advertisement event server; by the character block generation unit of the advertisement event server, generating the first character block, the n-th character block (n is natural number greater than or equal to 2), a first region to which the first character block is mapped, and an n-th region to which the n-th character block is mapped, wherein when the first character block is attached to the first region, the character twin is in a first state, and when the n-th block is attached to the n-th region, the character twin is in a second state; and when the character twin is in the second state, ending the event.

According to the present invention, there is an effect of returning a distribution margin to consumers by converting the distribution platform, such as Amazon or G-market, where operators exist, into a distribution platform centered on producers and consumers without a business operator while introducing a blockchain technology.

More specifically, according to the present invention, there is an effect of attracting consumers to collect character blocks through various distribution channels, in such a manner as to collect n character blocks constituting a character twin obtained by digitally imaging the actual event that an advertiser, producer, or seller wants to trade, such as compatible character blocks and incompatible character blocks.

In addition, according to the present invention, there is an effect of providing a system or method for an advertiser to objectively check the advertising effect numerically by storing and managing the participants of the character twin advertisement event of popular products in each block of the blockchain.

In addition, according to the present invention, there is an effect of attracting consumers to the real event object by providing the real event object to participants who are to be compensated by satisfying the conditions suggested by the advertiser, among participants of the character twin advertisement event for popular products.

In addition, according to the present invention, there is an effect of checking which distribution channel has the greatest advertising effect by storing and managing the distribution channels used by participants in the character twin advertisement event of popular products.

In addition, according to the present invention, it is possible to encrypt a safe that stores new cryptocurrency or airdrop coins with the private key of the magic key and the private key of the electronic wallet to record the same in each block of the blockchain, and decrypt the same with the public key of the magic key and the public key of the electronic wallet to provide the cryptocurrency or airdrop coins when participating in a character twin advertisement event and satisfying the advertiser's conditions.

In addition, according to the present invention, there is an effect that the advertiser can provide a system or method that can objectively check the advertising effect numerically, by storing and managing the participants of the character twin advertisement event of popular products in each block of the blockchain.

In addition, whenever the consumer terminal collects the character blocks one by one, since attribute information of the character block, character block tokens corresponding to the character block in a one-to-one manner, and an address of the second electronic wallet of the consumer terminal are recorded in each block of the blockchain, there is an effect that the advertiser has an effect of checking an address of the second electronic wallet of the consumer who actually collects the character block of the real event object.

In addition, whenever the consumer terminal collects one character block, the character block token corresponding to the character block in a one-to-one manner is stored in the address of the second electronic wallet of the consumer terminal, whereby the consumer can perform transaction with other desired securities or goods with the character block token.

In addition, whenever the consumer terminal collects one character twin, the character twin token and an address of the second electronic wallet of the consumer terminal are recorded in each block of the blockchain, whereby there is an effect that the advertiser can check the address of the second electronic wallet of the consumer who actually collects the character twin of the real event object.

In addition, whenever the consumer terminal collects one character twin, the consumer has ownership of the character twin tokens that corresponds to the characters twin in a one-to-one manner, whereby there is an effect that the consumer can obtain other securities or goods through transactions by character twin tokens.

In addition, by allowing the consumer terminal to transmit GPS data and mission information, it is possible to reflect the advertiser's intention to maximize the advertising effect by enticing consumers to visit a specific advertising place.

### BRIEF DESCRIPTION OF THE DRAWINGS

FIG. 1 is a diagram showing a character twin and a character block in a block-based method for real event object exchange according to the present invention.

FIG. 2 is a diagram showing brand character blocks and common character blocks of a character block in the block-based method for real event object exchange according to the present invention.

FIG. 3 is a diagram showing an apparatus for implementing the block-based method for real event object exchange according to an embodiment of the present invention.

FIG. 4 is a diagram showing a block-based method for real event object exchange according to an embodiment of the present invention.

FIG. 5 is a diagram illustrating inputting registration information of character blocks in an advertisement event server in the block-based method for real event object exchange according to the present invention.

FIG. 6 is a diagram illustrating inputting attribute information of brand character blocks in an advertisement event server in the block-based method for real event object exchange according to the present invention.

FIGS. 7, 8, and 9 are diagrams illustrating a process of collecting character blocks in the block-based method for real event object exchange according to the present invention.

FIG. 10 is a diagram illustrating that character blocks are collected and then character block numbers and GPS information of the character blocks are displayed in the active window, in the block-based method for real event object exchange according to the present invention.

FIG. 11 is a diagram illustrating a process of transferring character twin token ownership when an advertisement event end condition is obtained, in the block-based method for real event object exchange according to the present invention.

FIG. 12 is a diagram showing a process in which a consumer receives a character twin token by opening a safe smart contract, in the block-based method for real event object exchange according to the present invention.

### DETAILED DESCRIPTION

Hereinafter, a preferred embodiment of the present invention will be described with reference to the drawings.

First, a character twin 110 and a character block 120 are defined.

The character twin 110 is defined as a digital image obtained by implementing real event objects to be advertised or sold by advertisers, producers, or sellers with n character blocks 120 (n is a natural number equal to or greater than 2). When the character twin 110 is composed of n character blocks 120, each of n character blocks is defined as a character block 120.

The character twin 110 is a compound word of a visual character and a digital twin, in which the visual character is obtained by designing the appearance of unique characters or animals that appear in novels, cartoons, and plays. In addition, the digital twin is obtained by digitally copying assets virtualized in software, instead of physical assets that actually exist. For example, a digital twin technology may be capable of implementing a physical environment into a virtual environment by virtually copying and simulating the production facilities of the factory.

That is, the character twin 110 may be obtained by digitally copying the character in which a design is introduced into a real event object.

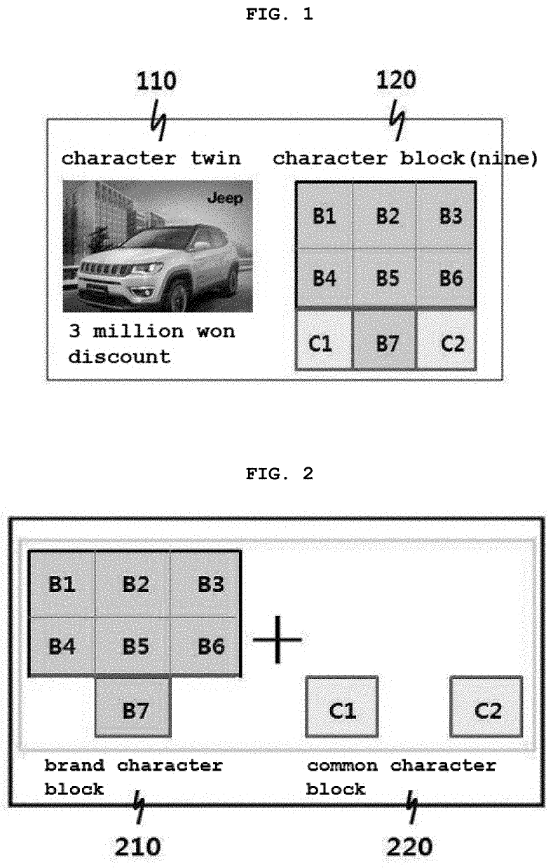

According to FIG. 1, for example, in the case that the real event object is a 3 million won discount coupon for Jeep COMPASS SUV car, a character obtained by inserting a design into a digital image of the real event object for the 3 million won discount coupon for Jeep COMPASS SUV car may be referred to as a character twin 110, and each of n character blocks 120 composing the character twin 110 may be referred to as a character block 120.

Although FIG. 1 shows that the character twin 110 and the character block 120 are separated from each other, it will be appreciated that the character twin 110 may be composed of n character blocks 120.

According to FIG. 2, the character block 120 includes brand character blocks 210 and common character blocks 220. The brand character block 210 is a character block 120 capable of being used only for a specific character twin 110, and the common character block 220 may be a character block 120 capable of being used for all character twins 110.

The brand character block 210 and the common character block 220 shown in FIG. 2 compose the character block 120 of the 3 million won discount coupon for Jeep COMPASS SUV car shown in FIG. 1. Herein, the brand character block 210 is capable of being used only for the 3 million won discount voucher for Jeep COMPASS SUV, and the common character block 220 is capable of being also used for other character twins 110. In addition, the brand character block 210 and the common character block 220 may be classified by shape or color.

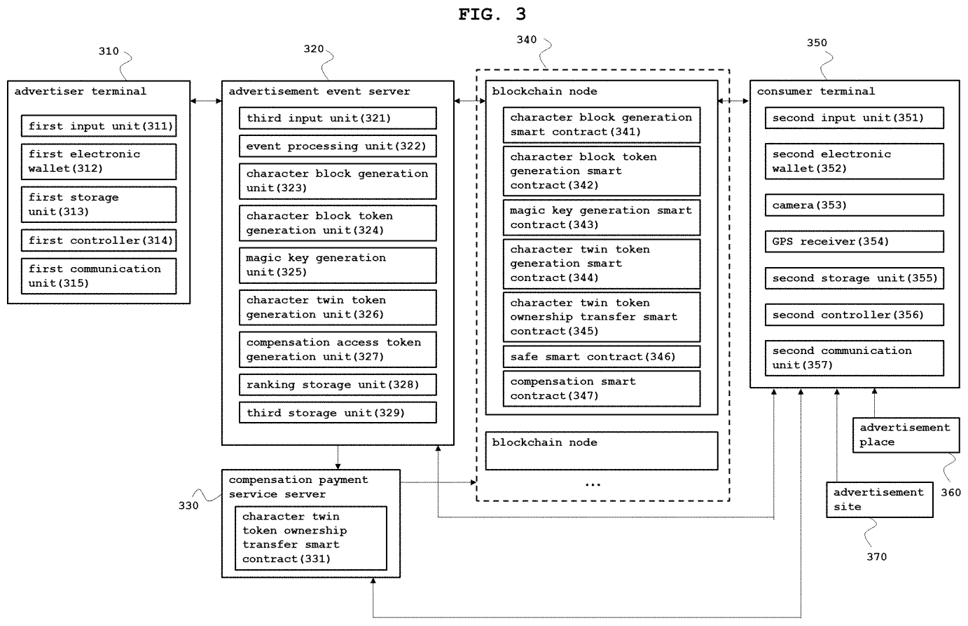

According to FIG. 3, an apparatus for implementing the block-based method for real event object exchange according to an embodiment of the present invention includes an advertiser terminal 310, an advertisement event server 320, a compensation payment service server 330, and a blockchain node 340, a consumer terminal 350, an advertisement site 370, and an advertisement place 360.

According to FIG. 3, the advertiser terminal 310 includes a first input unit 311 inputting a digital image of the real event object in the character twin 110, registration information for registering the n character blocks 120 constituting the character twin 110, compensation information provided to a consumer who is selected as compensation targets by participating in an advertisement event and collecting the n character blocks 120, and costs needed for the advertising event; a first electronic wallet 312 paying the cost consumed for the advertisement event in cryptocurrency and receiving the character twin 110 token returned by the consumer; a first storage unit 313 storing information input from the first input unit 311; a first communication unit 315 transmitting the information stored in the first storage unit 313 to the advertisement event server 320; and a first controller 314 controlling the first communication unit 315 to transmit the information input by the first input unit 311 to the advertisement event server 320.

According to an embodiment, the first input unit 311 may include a display unit.

According to an embodiment, the first storage unit 313 stores a web browser or an app browser, and the first input unit 311 may input the information through the web browser or the app browser stored in the first storage unit 313.

According to FIG. 3, the advertisement event server 320 includes a third input unit 321 inputting registration information for registering the digital image of the real event object in the character twin 110 and the n character blocks 120 constituting the character twin 110 into the advertisement event server 320; a character block generation unit 323 receiving a character block generation command according to the execution of a character block generation smart contract 341 stored in the blockchain node 340 to generate a plurality of character blocks 120; a character block token generation unit 324 receiving a character block token generation command according to the execution of a character block token generation smart contract 342 stored in the blockchain node 340 to generate a character block token; a magic key generation unit 325 receiving a magic key generation command according to the execution of a magic key generation smart contract 343 stored in the blockchain node 340 to generate a magic key; a character twin token generation unit 326 receiving a character twin token generation command according to the execution of a character twin token generation smart contract 344 stored in the blockchain node 340 to generate a character twin token; a compensation access token generation unit 327 generating a compensation access token according to the execution of a compensation smart contract 347 stored in the blockchain node 340; a ranking storage unit 328 storing the number of the character blocks 120 which are collected by the consumer participating in the advertisement event and the ranking thereof; a third storage unit 329 storing the digital image of the real event object input by the third input unit 321, registration information that allows the n character blocks 120 composing the character twin 110 to be registered into the advertisement event server 320, attribute information of the n character blocks input from a second input unit 351 of the consumer terminal 350, the character twin 110, the generated plurality of character blocks 120, a plurality of character block tokens corresponding to the plurality of character blocks 120 in a one-to-one manner, a character twin token corresponding to the character twin 110 in a one-to-one manner, and information generated during the advertisement event process; and an event processing unit 322 controlling the operation of the advertisement event server 320.

Referring to FIG. 3, the blockchain node 340 may store the character block generation smart contract 341, the character block token generation smart contract 342, the magic key generation smart contract 343, the character twin token generation smart contract 344, character twin token ownership transfer smart contracts 331 and 345, a safe smart contract 346, the compensation smart contract 347, and information generated during the advertisement event process and recorded in each block of the blockchain.

Each block of the blockchain may be defined as an arbitrary block in the blockchain in which a plurality of blocks is chained.

Vitalik Buterin developed Ethereum that allows for financial transactions such as payment and remittance, as well as smart contracts with extended functions to handle all kinds of contracts by using the blockchain technology based on Bitcoin.

The smart contract is made up of “conditions” and “executions”, which allow automatic transactions between contracting parties without an intermediary. As a code may be recorded in the blockchain to execute something when a certain condition is satisfied, the smart contract in the blockchain may be automatically executed according to execution contents written in scripts in the blockchain when the contract condition is satisfied.

Therefore, according to the present invention, the plurality of smart contracts may be executed in sequence when advertising event costs are paid according to the ERC721 standard-based non-fungible token generation process.

That is, when the advertising event cost is paid, the character block generation smart contract 341 may be executed so that the character block generation unit 323 generates the character block 120, and the character block generation smart contract 341 may be executed so that the character block token generation unit 324 may generate the character block token.

In addition, when the consumer collects all of the plurality of character blocks 120, the magic key generation smart contract 343 may be executed so that the magic key generation unit 325 generates a private key and a public key of the magic key, the character twin token generation smart contract 344 may be executed so that the character twin token generation unit 326 generates the character twin token, whereby the private key of the magic key may be stored in the generated character twin token.

When the end condition of the advertisement event is met, the character twin token ownership transfer smart contracts 331 and 345 are executed to transfer ownership of the character twin token from the advertiser to the consumer.

When the end condition of the advertisement event is met, the compensation smart contract 347 is executed to generate the compensation access token, whereby a specific compensation procedure starts.

In addition, a consumer who acquires ownership of the character twin token storing the magic key transmits a “real object information transfer request message” to the safe smart contract 346 stored in the blockchain node 340, with encrypting the same with the private key of the magic key and a private key of a second consumer electronic wallet 352.

Subsequently, the safe smart contract 346 decrypts the “real object information transfer request message” with the private key of the second consumer electronic wallet 352 and the public key of the magic key, and transmits the security and/or cryptocurrency capable of being exchanged for the real event object stored in the safe smart contract 346 to the address of the second consumer electronic wallet 352.

According to an example, the blockchain node 340 may store the information for recoding the character twin 110, the plurality of character blocks 120, attribute information of the plurality of character blocks, the character block token, the character twin token, and the address of the second consumer electronic wallet 352 in each block of the blockchain.

Hereinafter, it will be described why the character block token and the character twin token are needed, in addition to the character twin 110 and the character block 120.

When the character twin 110 or the character block 120 is an image worth the money, it may be a target of transaction. However, since the character twin 110 or the character block 120 is only a digital image of the real event object or a piece of the digital image, it is not easy to distinguish between the original and the copy.

Therefore, the transaction cannot be performed with the character twin 110 or the character block 120. Accordingly, the character block token or the character twin token may be required to perform the transaction with the character twin 110 or the character block 120.

The character block tokens may correspond to the character blocks in a one-to-one manner, and the character twin tokens may correspond to the character twins in a one-to-one manner.

In addition, since the character block tokens or the character twin tokens are traded in a virtual space, an electronic wallet is needed to trade the same. Therefore, in the block-based method for real event object exchange according to the present invention, a first electronic wallet 312 of the advertiser terminal 310 and a second consumer electronic wallet 352 of the consumer terminal 350 are included.

According to FIG. 3, the consumer terminal 350 may include the second input unit 351, the second consumer electronic wallet 352 receiving the security and/or cryptocurrency of corresponding to the real event object received by a consumer selected as a compensation target by participating in the advertisement event; a camera 353 inputting a digital code; a GPS receiver 354 receiving advertisement location information of the brand character block 210; a second storage unit 355 inputting the digital code from the camera 353 and storing an application capable of inputting attribute information of the plurality of character blocks 120 and the attribute information of the plurality of character blocks 120 input by the application; a second communication unit 357 transmitting the attribute information of the plurality of character blocks 120 stored in the second storage unit 355 to the advertisement event server 320; and a second controller 356 controlling the operation of the consumer terminal 350 during the advertisement event.

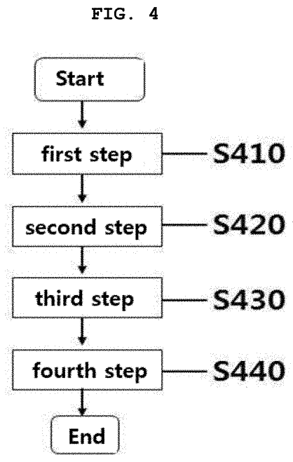

According to FIG. 4, the block-based method for real event object exchange according to the present invention includes a first step S410 of inputting registration information of a character twin and a plurality of character blocks; a second step S420 of generating the plurality of character blocks and a plurality of character block tokens corresponding to the plurality of character blocks in a one-to-one manner; a third step S430 of executing an advertisement event that allows for collecting the generated character blocks and character block tokens and generating a magic key and character twin tokens corresponding to the character twins in a one-to-one manner; and a fourth step S440 of ending the advertisement event according to the end condition of the advertisement event and then performing compensation for a selected compensation target consumer.

In the first step S410 in the block-based method for real event object exchange according to the present invention, the first input unit 311 of the advertiser terminal 310 or the third input unit 321 of the advertisement event server 320 may connect and log in to the advertisement event server 320.

Subsequently, the advertiser terminal 310 or the advertisement event server 320 may input a character twin 110 obtained by imaging the real event object in a digital manner.

The advertisement event server 320 may generate a virtual block set matching the character twin 110, and the virtual block set may be generated for each character twin 110.

Herein, the block set may be divided into a plurality of regions, and each character block 120 may correspond to each region.

The advertiser terminal 310 or the advertisement event server 320 inputs the registration information of the plurality of character blocks 120, and the advertisement event server 320 may generate the plurality of character blocks 120 by dividing the block set into each region according to the registration information of the character block 120.

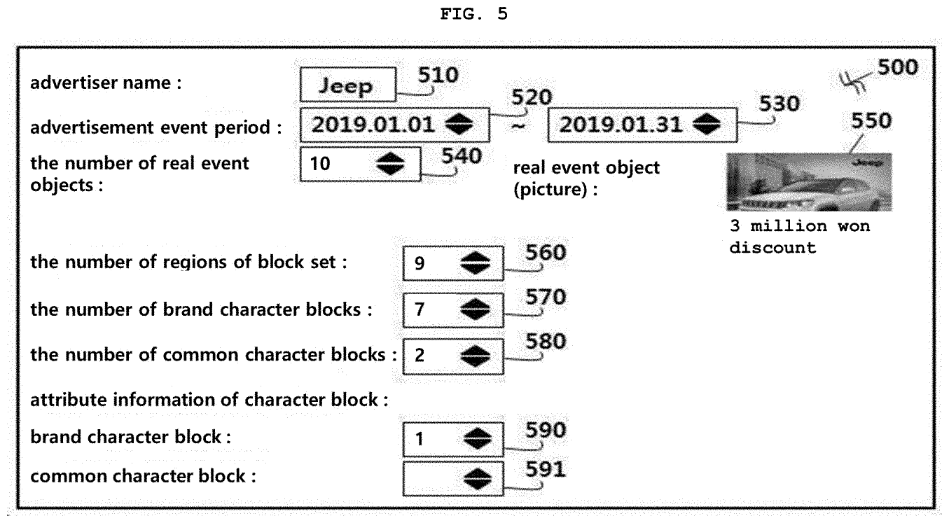

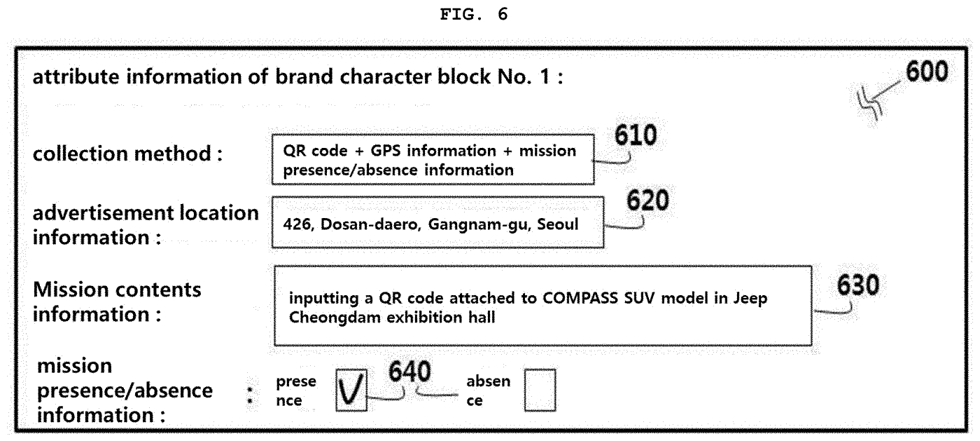

Referring to FIGS. 5 and 6, the advertiser terminal 310 or the advertisement event server 320 may input the registration information of the plurality of character blocks 120, including at least one of an advertiser name 510, an advertisement event period 520, 530, the number of real event objects 540, the number of regions of the block set 560, the number of brand character blocks 570, the number of common character blocks 580, a brand character block number 590 in which attribute information is entered, a public character block number 591 in which attribute information is entered, a collection method 610 of the brand character block, advertisement location information 620 of the brand character block, mission contents information 630 of the brand character block, and mission presence/absence information 640

Referring to FIG. 6, the advertisement location information 620 may include GPS information on a map where the brand character block 210 may be found.

Referring to FIG. 6, the mission contents information 630 may include mission contents capable of being performed with the advertisement location information to find the brand character block 210.

Referring to FIG. 6, the mission presence/absence information 640 may include information indicating there is the mission content information or not.

According to an example, the input registration information of the plurality of character blocks 120 may be stored in the third storage unit 329 of the advertisement event server 320.

Referring to FIG. 5, for example, a case of registering ten 3 million won discount coupons for Jeep COMPASS SUV model to the advertisement event server 320 will be described.

As shown in FIG. 5, an advertiser name 510 is Jeep, and advertisement event periods 520 and 530 may be from Jan. 1, 2019 to Jan. 31, 2019.

As shown in FIG. 5, the real event object is a 3 million won discount coupon for Jeep COMPASS SUV model, and a digital image 550 of the 3 million won discount coupon for Jeep COMPASS SUV model is input. The number of real event objects 540 may be 10.

According to FIG. 5, the number 560 of regions of the block set is nine, the number 570 of brand character blocks is seven, and the number 580 of the common character blocks may be two.

FIG. 5 shows a full screen in which the registration information of the plurality of character blocks 120 is input, and thus it is possible to input common information among the registration information of the plurality of character blocks 120 in the 3 million won discount coupon for Jeep COMPASS SUV model.

In addition, when the brand character block number 590 in which the attribute information is input is selected in FIG. 5, the attribute information corresponding to the selected brand character block number may be input, as shown in FIG. 6.

In addition, when the common character block number 591 in which attribute information is input is selected in FIG. 5, the attribute information corresponding to the selected common brand block number may be input, as shown in FIG. 6.

According to FIGS. 5 and 6, the attribute information of the brand character block No. 1 590 may include the collection method 610, the advertisement location information 620, the mission contents information 630, and the presence/absence of mission information 640.

Referring to FIGS. 5 and 6, the collection method 610 indicates QR code+GPS information+mission presence/absence information a method for collecting the brand character block No. 1 590.

Referring to FIG. 5, in order to collect the brand character block No. 1 590, it may include entering the QR code, entering the GPS information, and entering the mission presence/absence information.

Referring to FIG. 6, the advertisement location information 620 with the digital code indicates 426 Dosan-daero, Gangnam-gu, Seoul, which is the address of a Jeep Cheongdam Exhibition Hall, as offline GPS information, and the mission presence/absence information 640 may indicate presence.

Referring to FIGS. 5 and 6, in order to collect the No. 1 brand character block 590, it is noted that a QR code attached to the COMPASS SUV model arranged in the Jeep Cheongdam Exhibition Hall located at 426 Dosan-daero, Gangnam-gu, Seoul should be entered.

Referring to FIG. 6, the collection method 610 of the specific brand character block 210 may indicate QR code+GPS information.

Herein, it is noted that a QR code placed in an offline corresponding to the GPS information should be input.

Here, the digital code may include a QR code, a DataMatrix code, and a barcode. In addition, the QR code may include a DataMatrix code and a barcode, as an example of a digital code.

Referring to FIG. 6, the mission contents information 630 may include a plurality of mission contents.

According to an example, the advertisement location information 620 may include link information of the advertisement site 370 on online, where the public character block 220 may be found.

As an embodiment, the character twin 110 according to the present invention may be also applied to a popular product or service, such as a BTS album, an Iron Man miniature, air tickets to the USA, foreign cars, etc.

The advertisement site 370 may include a site including 11th Street, Auction, and Gmarket, advertisements for YouTube videos, advertisements on SNS such as KakaoTalk or Facebook, and paper media such as flyers, magazines, and newspapers.

As an example, the first input unit 311 of the advertiser terminal 310 may pay an advertisement event cost, including an amount of the real event objects to be paid to a compensation target among consumers who participate in the advertisement event.

Referring to FIGS. 5 and 6, when the collection method 610 of the brand character block 210 is QR code+GPS information, the consumer may collect the brand character block 210 at a specific place.

Referring to FIGS. 5 and 6, the collection method 610 of the brand character block 210 indicates QR code+GPS information+mission presence/absence information. When the above mission presence/absence information indicates presence, the consumer should perform a specific mission in a specific place to collect the brand character block 210.

In the second step S420 of the block-based method for real event object exchange according to the present invention, the plurality of character blocks 120 and the plurality of character block tokens may be generated according to the input registration information of the plurality of character blocks 120.

The plurality of character blocks 120 may be stored in the third storage unit 329 of the advertisement event server 320.

Subsequently, the advertisement event server 320 generates the character block tokens corresponding to the character blocks 120 in a one-to-one manner, and herein the character block tokens may be recorded in each block of the blockchain.

In the block-based method for real event object exchange according to the present invention, a method of generating the plurality of character blocks 120 in the advertisement event server 320 and the blockchain node 340 will be specifically described.

As an embodiment, when the advertiser completes the payment for the advertisement event, the blockchain node 340 may transmit the execution command of an ERC721-based non-fungible token generation processor to the event processing unit 322 of the advertisement event server 320.

Subsequently, the event processing unit 322 of the advertisement event server 320 may generate and assign an advertisement event ID.

Subsequently, the event processing unit 322 of the advertisement event server 320 may instruct the character block generation unit 323 of the advertisement event server 320 to generate the plurality of character blocks 120 according to the execution of the character block generation smart contract 341 stored in the blockchain node 340.

Subsequently, the character block generation unit 323 generates the plurality of character blocks 120 from the character twin 110 obtained by digitally imaging the real event object and the input registration information of the plurality of character blocks 120, and stores the generated character blocks 120 in the third storage unit 329 of the advertisement event server 320.

Then, the event processing unit 322 of the advertisement event server 320 receives the execution command of the character block token generation smart contract 342 transmitted from the blockchain node 340 and transmits the same to the character block token generation unit 324.

Then, the character block token generation unit 324 may generate a plurality of character block tokens corresponding to the generated plurality of character blocks 120 in a one-to-one manner, and the advertisement event server 320 may record the generated plurality of character block tokens in each block of the blockchain.

The character block token may include at least one of an advertisement ID, an address of the first electronic wallet 312 of the advertiser, a number of the character block 120, and ownership information of the character block 120.

In the third step S430 of the block-based method for real event object exchange according to the present invention, when the attribute information of the character block 120 is input from the consumer terminal 350, the advertisement event server 320 may initiate an advertisement event in which the character block 120 is virtually attached to the block set.

The consumer terminal 350 collects all of the plurality of character blocks 120, and the magic key generator 325 of the advertisement event server 320 may generate a private key and a public key of the magic key. A process of collecting the plurality of character blocks 120 will be described below.

The character twin token generator of the advertisement event server 320 may generate a character twin token that records the private key of the magic key, and record the generated character twin token in each block of the blockchain.

Subsequently, when the consumer terminal 350 collects all of the plurality of character blocks 120, the advertisement event server 320 may generate the character twin token corresponding to the character twin 110 and record the character twin token in each block of blockchain.

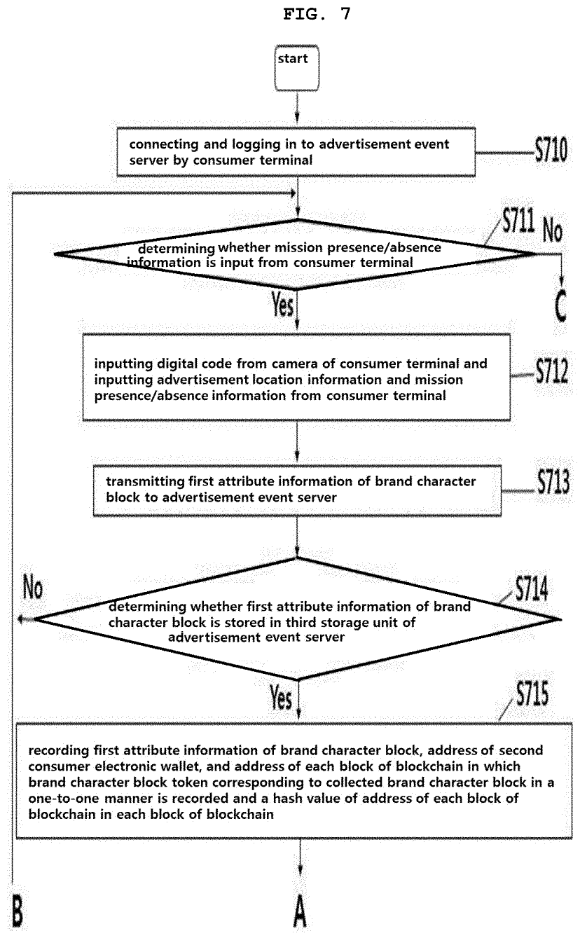

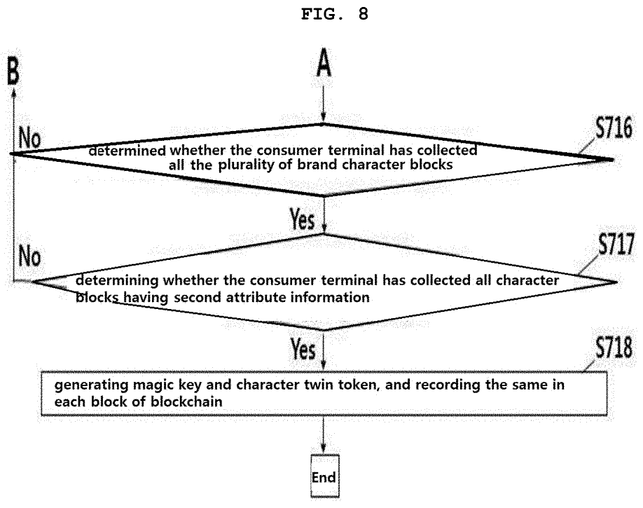

Referring to FIGS. 7 and 8, a process of collecting the character blocks in the block-based method of real event object exchange according to the present invention will be described.

The second input unit 351 of the consumer terminal 350 may connect and log in to the advertisement event server 320 (S710).

Then, the event processing unit 322 of the advertisement event server 320 may determine whether the mission presence/absence information 640 is input from the consumer terminal 350 or not (S711).

Then, when the mission presence/absence information 640 is input, the digital code may be input from the camera 353 of the consumer terminal 350, and the advertisement location information 620 from the GPS receiver 354 of the consumer terminal 350 and the mission presence/absence information 640 indicating whether there is the mission contents information 630 requesting to the consumer in the advertisement location information 620 may be input (S712).

Subsequently, a number of the brand character block 210 input from the digital code, and first attribute information of the brand character block 210 including the advertisement location information 620, and the mission presence/absence information 640 may be transmitted to the event processing unit 322 of the advertisement event server 320 (S713).

Subsequently, the event processing unit 322 of the advertisement event server 320 may determine whether the received first attribute information of the brand character block 210 is stored in the third storage unit 329 of the advertisement event server 320 (S714).

Subsequently, when the first attribute information of the brand character block 210 is stored in the third storage unit 329 of the advertisement event server 320, the collected attribute information of the brand character block 210, an address of the second consumer electronic wallet 352, and an address of each block of the blockchain in which the brand character block token corresponding to the collected brand character block in a one-to-one manner is recorded and a hash value of the address of each block of the blockchain may be recorded in each block of the blockchain (S715).

That is, only when it is determined that the first attribute information of the brand character block 210 input from the consumer terminal 350 is stored in the third storage unit 329 of the advertisement event server 320, the consumer who has the consumer terminal 350 may be a consumer who collects the brand character block 210.

Therefore, when the first attribute information of the brand character block 210 input from the consumer terminal 350 is not stored in the third storage unit 329 of the advertisement event server 320, the consumer who has the consumer terminal 350 may be not a consumer that collects the brand character block 210.

Whenever the consumer collects one brand character block 210, the event processing unit 322 of the advertisement event server 320 may store the collected first attribute information of the brand character block 210, the address of the second consumer electronic wallet 352, and an address of each block of the blockchain in which the brand character block token corresponding to the collected brand character block in a one-to-one manner is recorded and an address of each block of the blockchain in which a hash value of the address of each block of the blockchain is recorded, in the third storage unit 329 of the advertisement event server 320.

Whenever the consumer collects one brand character block 210, the event processing unit 322 of the advertisement event server 320 may transmit the collected first attribute information of the brand character block 210, and an address of each block of the blockchain in which the brand character block token corresponding to the collected brand character block in a one-to-one is recorded, and an address of each block of the blockchain in which a hash value of the address of each block of the blockchain is recorded, to the second consumer electronic wallet 352, and store the same in the second consumer electronic wallet 352 of the consumer terminal 350.

That is, when the first attribute information of the brand character block 210 is stored in the third storage unit 329 of the advertisement event server 320, the consumer terminal 350 may be authenticated by the advertisement event server 320 that the brand character blocks 210 are collected.

Then, it may be determined whether the consumer terminal 350 has collected all the plurality of brand character blocks 210 (S716).

Then, it may be determined whether the consumer terminal 350 has collected all of the character blocks 120 having the second attribute information (S717).

Subsequently, when the consumer terminal 350 collects all of the plurality of brand character blocks 120 having the second attribute information, a public key of the magic key and a private key of the magic key capable of opening the public key of the magic key are generated, and a character twin token is generated, whereby the generated private key of the magic key is recorded in the character twin token, and the character twin token and the address of the second consumer electronic wallet 352 may be recorded in each block of the blockchain (S718).

In addition, the character twin token includes at least one of a token ID, an address of a first advertiser electronic wallet 312, an advertisement ID, an address of the safe smart contract 346, a private key value of the magic key, and owner information of the character twin token.

Meanwhile, a consumer who has collected one or more of the brand character blocks 120 may make a transaction with the brand character block token stored in the second consumer electronic wallet 352. That is, when the brand character block 120 is an important character block, or the character twin itself is traded at a high price, only one character block token may be a transaction target.

Since the generated public key value of the magic key is added to the safe smart contract 346, when the consumer reserving the character twin token finds the address of the safe smart contract 346 with the private key value of the magic key and then combines the same with the public key value of the magic key, the safe smart contract 346 may be executed.

In addition, when the first attribute information of the brand character block 210 is not stored in the third storage unit 329 of the advertisement event server 320, the method may proceed to the step S711 of determining whether the mission presence/absence information 640 is input from the consumer terminal 350.

Then, it is checked whether the consumer terminal 350 has collected all of the plurality of brand character blocks 210, and when at least one of the plurality of brand character blocks 210 is not collected, the method may proceed to the step S711 of determining whether the mission presence/absence information 640 is input from the consumer terminal 350.

In addition, it is checked whether the consumer terminal 350 has collected all the character blocks 120 having the second attribute information, and when at least one character block 120 having the second attribute information is not collected, the method may proceed to the step S711 of determining whether the mission presence/absence information 640 is input from the consumer terminal 350.

According to FIG. 8, when a number of the received brand character block 210 is recorded in each block of the blockchain, and then a digital code having the same number as a number of the character block 120 is input from the camera 353 of the consumer terminal 350, a number of the character block 120 and the advertisement location information 640 may be displayed in an active window 810 over the digital code input from the camera 353 of the consumer terminal 350.

FIGS. 7 and 8 show corresponding sequences in the event processing unit 322 of the advertisement event server 320, when the attribute information of the brand character block 210 including the mission presence/absence information 640 among the registration information of the character block 120 is input from the second input unit 351 of the consumer terminal 350.

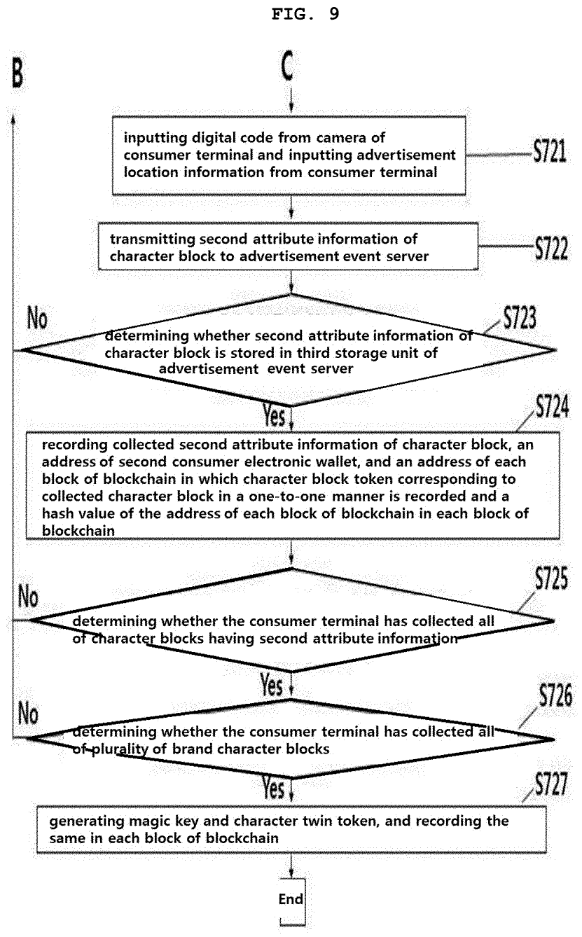

Referring to FIGS. 7 and 9, in the fourth step of the block-based method for real event object exchange according to the present invention, the second input unit 351 of the consumer terminal 350 may connect and log in to the advertisement event server 320 (S710).

Then, it may be determined whether the mission presence/absence information 640 is input from the second input unit 351 of the consumer terminal 350 (S711).

When the mission presence/absence information 640 is not input, the digital code may be input from the camera 353 of the consumer terminal 350, and the advertisement location information 640 may be input from the consumer terminal 350 (S721).

When the mission presence/absence information 640 is not input, the character block 120 may be a common character block 220, and the character block 120 may be also a brand character block 210 having QR code+GPS information as the collection method 610.

Herein, GPS information or an online advertisement site 370 may be input from the second input unit 351 of the consumer terminal 350, as advertisement location information 640.

Therefore, when the mission presence/absence information 640 is not input, the character block 120 may include the common character block 220 and the brand character block 210.

Then, the second attribute information of the character block 120 including a number of the character block 120 input from the digital code and the advertisement location information 640 may be transmitted to the event processing unit 322 of the advertisement event server 320 (S722).

Then, the event processing unit 322 of the advertisement event server 320 may determine whether the received second attribute information of the character block 120 is stored in the third storage unit 329 of the advertisement event server 320 (S723).

Then, when the second attribute information of the character block 120 is stored in the third storage unit 329 of the advertisement event server 320, the collected second attribute information of the character block 120, an address of the second consumer electronic wallet 352, and an address of each block of the blockchain in which a character block token corresponding to the collected character block 120 in a one-to-one manner is recorded and a hash value of the address of each block of the blockchain may be recorded in each block of the blockchain (S724).

That is, only when it is determined that the second attribute information of the character block 120 input from the consumer terminal 350 is stored in the third storage unit 329 of the advertisement event server 320, the consumer who has the consumer terminal 350 may be a consumer who collects the character block 120.

Therefore, when the second attribute information of the character block 120 input from the consumer terminal 350 is not stored in the third storage unit 329 of the advertisement event server 320, the consumer who has the consumer terminal 350 may be not a consumer who collects the character block 120.

Whenever the consumer collects one character block 120, the event processing unit 322 of the advertisement event server 320 may store the collected second attribute information of the character block 120, the address of the second consumer electronic wallet 352, and an address of each block of the blockchain in which the character block token corresponding to the collected character block 120 in a one-to-one is recorded and an address of each block of the blockchain in which a hash value of the address of each chain block of the blockchain is recorded, in the third storage unit 329 of the advertisement event server 320.

Whenever the consumer collects one character block 120, the event processing unit 322 of the advertisement event server 320 may transmit the collected second attribute information of the character block 120, and an address of each block of the blockchain in which the brand character block token corresponding to the collected brand character block in a one-to-one is recorded, and an address of each block of the blockchain in which a hash value of the address of each block of the blockchain is recorded, to the second consumer electronic wallet 352, and store the same in the second consumer electronic wallet 352 of the consumer terminal 350.

Then, it may be determined whether the consumer terminal 350 has collected all of the character blocks 120 having the second attribute information (S725).

Then, it may be determined whether the consumer terminal 350 has collected all of the plurality of brand character blocks 210 (S726).

Then, when it is determined that the consumer terminal 350 has collected both the character block 120 having the second attribute information and the plurality of brand character blocks 210, the public key and private key of the magic key are generated, and the character twin token is generated, whereby the generated private key of the magic key is stored in the character twin token, and the character twin token and the address of the second consumer electronic wallet 352 may be recorded in each block of the blockchain (S727).

The character twin token may include at least one of a token ID, an address of the first advertiser electronic wallet 312, an advertisement ID, an address of the safe smart contract 346, a private key value of the magic key, and owner information of the character twin token.

Since the generated public key value of the magic key is added to the safe smart contract 346, when the consumer reserving the character twin token finds the address of the safe smart contract 346 with the private key value of the magic key and then combines the same with the public key value of the magic key, the safe smart contract 346 may be executed.

In addition, when the second attribute information of the character block 120 is not stored in the third storage unit 329 of the advertisement event server 320, the method may proceed to the step S711 of determining whether the mission presence/absence information 640 is input from the consumer terminal 350.

Then, it is checked whether the consumer terminal 350 has collected all of the plurality of character blocks 120 having the second attribute information, and when at least one of the plurality of character blocks 120 having the second attribute information is not collected, the method may proceed to the step S711 of determining whether the mission presence/absence information 640 is input from the consumer terminal 350.

In addition, it is checked whether the consumer terminal 350 has collected all the brand character blocks 210, and when at least one brand character block 210 is not collected, the method may proceed to the step S711 of determining whether the mission presence/absence information 640 is input from the consumer terminal 350.

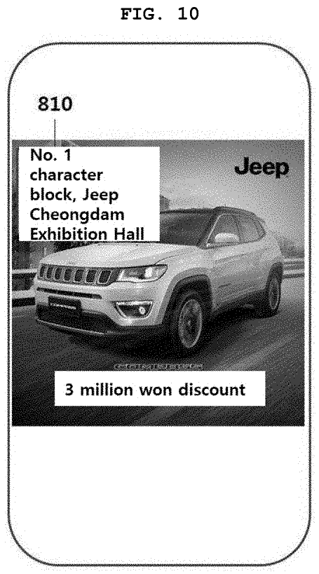

According to FIG. 10, when a number of the received character block 120 is recorded in each block of the blockchain, and then a digital code having the same number as a number of the character block 120 is input from the camera 353 of the consumer terminal 350, a number of the character block 120 and the advertisement location information 640 may be displayed in an active window 810 over the digital code input from the camera 353 of the consumer terminal 350.

In addition, in FIG. 10, when the digital code of the character block that has not been collected is input, a number of the character block 120 and the advertisement location information may be displayed on an inactive window over a digital code input from the camera 353 of the consumer terminal 350.

FIG. 9 shows a case in which the second attribute information of the common character block 220 or the brand character block 210 without the mission presence/absence information 640 among the registration information of the character block 120 is input from the second input unit 351 of the consumer terminal 350.

According to an embodiment, a character twin token in which attribute information on the character twin 110 is encrypted is generated, a character block token in which attribute information of the plurality of character blocks 120 in encrypted to be distinguished for each region of the block set is generated, the character twin token and each of the character block tokens may be stored in each block of blockchain.

As shown in FIG. 3, the event processing unit 322 may count the number of character blocks 120 and the number of occurrences of character twin tokens for each consumer, and store the same in the ranking storage unit 328.

According to an embodiment, when generating the character twin token in the advertisement event server 320, it is possible to notify the consumer of the number of occurrences of character twin token stored in the ranking storage unit 328 while recording the same in each block of the blockchain.

The number of occurrences of the character twin token may also be linked to the advertisement event end condition.

According to an embodiment, the end condition of the advertisement event may be determined when programming the character twin token ownership transfer smart contracts 331 and 345. For example, when the event start time and end time are input, the event end time may be the end condition for the advertisement event.

In the case that the end condition of the advertisement event is to find all the character blocks 120, the advertisement event ends when all the generated character blocks 120 are found.

Here, in the state of capturing the digital code using the camera 353 of the consumer terminal 350, a number of the character block 120 and advertisement location information 620 should be input. Therefore, when capturing the digital code with the camera 353 of the consumer terminal 350, the consumer should operate an App for the consumer terminal 350, which is capable of inputting GPS data of the capturing location or the GPS data and the mission presence/absence information 640.

In addition, when the digital code is captured with a camera 353 equipped with an App for the consumer terminal 350 that can input GPS data of the shooting location, the second communication unit 357 of the consumer terminal 350 transmits a number of the character block 120 and GPS data, or a number of the character block 120, GPS data, and the mission presence/absence information 640, to the advertisement event server 320.

When capturing the digital code with the camera 353 of the consumer terminal 350, the reason why the GPS data and the mission presence/absence information should be added is explained below.

For example, when a person who wants to have No. 1 of the brand character blocks 210 of the character twin 110 in the 3 million won discount coupon for Jeep COMPASS SUV model may attempt to reserve the No. 1 of the brand character blocks 210 of the character twin 110 in the 3 million won discount coupon of Jeep COMPASS SUV model, by asking someone to capture the digital code and receiving the same with the smartphone, without directly visiting the Jeep Cheongdam Exhibition Hall.

Herein, the person who collects the No. 1 of the brand character blocks 210 of the character twin 110 in the 3 million won discount coupon for Jeep COMPASS SUV model transmits GPS data of a place other than the Jeep Cheongdam Exhibition Hall to the advertisement event server 320. Herein, the GPS data of the place other than the Jeep Cheongdam Exhibition Hall is not stored in the third storage unit 329 of the advertisement event server 320 and thus not recorded in each block of the blockchain. Therefore, the person fails to collect the No. 1 of the brand character blocks 210 of the character twin 110 in the 3 million won discount coupon for Jeep COMPASS SUV model.

Meanwhile, when the mission contents information 630 is stored in the third storage unit 329 of the advertisement event server 320 for the specific brand character block 210, similarly to the GPS data, the consumer should carry out the mission contents.

For example, when the digital code for the No. 1 of the brand character blocks 210 of the character twin 110 in the 3 million won discount coupon of Jeep COMPASS SUV model is printed on the Jeep COMPASS SUV model exposed in the Jeep Cheongdam Exhibition Hall, the mission of capturing the QR code printed on the Jeep COMPASS SUV model exposed in the Jeep Cheongdam Exhibition Hall should be performed, in order to collect the No. 1 of the brand character blocks 210 of the character twin 110 in the 3 million won discount coupon for Jeep COMPASS SUV model.

In addition, the mission contents information may include a plurality of pieces of mission contents information. Herein, the consumer may have to perform two missions in the advertisement place 360 corresponding to the GPS data in order to collect one brand character block 210.

In the fourth step S440 of the block-based method for real event object exchange according to the present invention, the end condition for the collection of the character block 120 is achieved so that the character twin 110 may be exchanged for the real event object.

In addition, when the end condition of the advertisement event is met, a progress result of the event may be notified to a consumer terminal 350 of a consumer selected to be exchanged for the real event object corresponding to the character twin 110 by participating in the advertising event.

According to an example, in the case that the end condition is to fill the character blocks 120 in all regions of the block set, when the above end conditions are met, the real event object may be provided to a consumer who has the character twin 110.

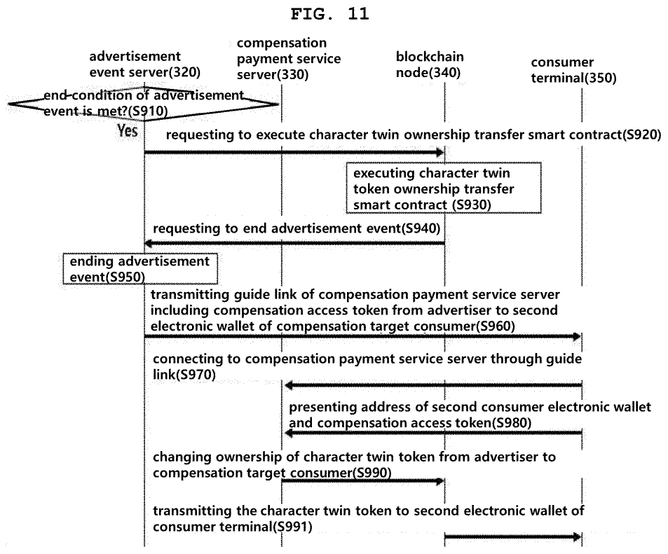

According to FIG. 11, in the fourth step of the block-based method for real event object exchange according to the present invention, when the end condition is met (S910), as the character twin token ownership transfer smart contracts 331 and 345 stored in the blockchain node 340 are executed (S930), it is possible to request the event processing unit 322 of the advertisement event server 320 to end the advertisement event (S940).

Then, the event processing unit 322 ends the advertisement event (S950), and the event processing unit 322 may select a compensation target consumer from among consumers who have collected the plurality of character blocks 120 and notify him/her of the compensation.

Subsequently, a guide link of the compensation payment service server 330 including the compensation access token may be transmitted from the advertiser to an address of the second electronic wallet 352 in the terminal 350 of the compensation target consumer (S960).

The consumer terminal 350 may connect to the compensation payment service server 330 through the guide link (S970).

Subsequently, the consumer terminal 350 may present the address of the second consumer electronic wallet 352 and the compensation access token to the character twin token ownership transfer smart contracts 331 and 345 of the compensation payment service server 330 (S980).

Subsequently, the character twin token ownership transfer smart contracts 331 and 345 stored in the compensation payment service server 330 verify the compensation access token presented by the consumer and change the ownership of the character twin token stored in the blockchain node 340 from the advertiser to the compensation target consumer (S990).

Subsequently, the blockchain node 340 may transmit the character twin token to the address of the second electronic wallet 352 of the consumer terminal 350 (S991).

In addition, the consumer who has transferred the ownership of the character twin token may make transaction with the character twin token stored in the second consumer electronic wallet 352.

According to an embodiment, the character twin token ownership transfer smart contracts 331 and 345 may include the address of the second electronic wallet 352 of the compensation target consumer.

The compensation access token is generated by the compensation access token generation unit 327 of the advertisement event server 320, and includes the address of the second electronic wallet 352 of the compensation target consumer.

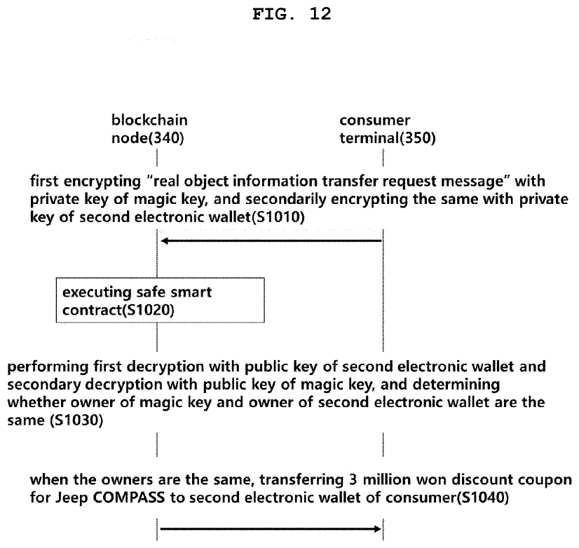

According to FIG. 12, in the fourth step of the block-based method for real event object exchange according to the present invention, when the end condition for the collection of the character block 120 is met, the ownership of the character twin token in the character twin token may be changed from the advertiser to the consumer.

Subsequently, when the above end condition is met, the “real object information transfer request message” is first encrypted with the private key of the magic key, secondarily encrypted with the private key of the second electronic wallet 352, and then transmitted to the blockchain node 340 (S1010).

Then, the blockchain node 340 executes the safe smart contract (S1020) so that the “real object information transfer request message” is decrypted with the public key of the second electronic wallet 352 and decrypted with the public key of the magic key, to determine whether the owner of the character twin token and the owner of the magic key are the same person (S1030).

Then, when the owner of the character twin token and the owner of the magic key are the same, the securities and/or cryptocurrency capable of being exchanged for the real event object may be transferred to the address of the second electronic wallet 352 (S1040).

According to an example, the safe smart contract 346 stores the securities capable of being exchanged for the real event object corresponding to the character twin 110 and records the public key of the magic key. When the private key of the magic key, which is input by the consumer, matches the public key of the magic key, a function of opening the safe is performed.

For example, when the end condition of the advertisement event is that there are 100 first-come-first-served customers among consumers who find all of the character blocks 120, the 100 consumers who own the character twin token may receive securities capable of being exchanged for the real event object.

In addition, for example, in the case that the end condition of the advertisement event is to reach the end time of the advertisement event, when the advertiser provides cryptocurrency as a reward amount, the consumers may each receive the amount obtained by dividing an amount of the cryptocurrency by the number of consumers who own the character twin token until the end time of the advertisement event.

In addition, for example, in the case that the end condition of the advertisement event is to reach the end time of the advertisement event, the advertiser may provide both the real event object and cryptocurrency to the first 100 consumers who own the character twin token and provide only cryptocurrency to consumers who own the character twin token after the first 100 consumers by the advertisement event deadline.

According to an embodiment, the safe smart contract may receive the character twin token stored in the address of the second electronic wallet 352 of the consumer, and return the same to the first electronic wallet 312 of the advertiser.

According to an embodiment, when the owner is the same person, the real event object information transfer request message may be transferred through another route, such as an e-mail address and SNS address of the owner.

According to an embodiment, in the block-based method for real event object exchange according to the present invention, the real event object corresponding to the character twin 110 in a one-to-one manner may be input from the advertiser terminal 310 to the advertisement event server 320.

Herein, the character block generation unit 323 of the advertisement event server 320 may generate the first character block 120, the n-th character block 120 (n is natural number greater than or equal to 2), a first region to which the first character block 120 is mapped, and an n-th region to which the n-th character block 120 is mapped.

When the first character block 120 is attached to the first region, the character twin 110 is in a first state, and when the n-th block is attached to the n-th region, the character twin 110 is in a second state. When the character twin 110 is in the second state, the event ends.

Subsequently, some of the first to the n-th regions may be used only for a specific character twin, and the remaining part of the first to the n-th regions may be used for other character twins.

According to an embodiment, in the block-based method for real event object exchange according to the present invention, an advertiser who supplies m real event objects (m is a natural number greater than or equal to 2) may pay an amount of the m real event objects and a reward amount to the consumer who collects the plurality of character blocks 120 and has the character twin 110.

When the end condition is achieved at the end time set by the advertiser, the advertiser may pay an amount obtained by dividing the amount of the real event object and a reward amount by the number of the first to the m-th consumers who have the character twin 110, to each of the first to m-th consumers among consumers who have the character twin 110 until the end time.

In addition, the advertiser may pay only an amount obtained by dividing a reward amount by the number of consumers who have the character twin 110 to consumers after the m+1-th consumer among consumers who have the character twin 110 until the end time.

Although the embodiments according to the present invention have been described above, this is only exemplary, and those of ordinary skill in the art will understand that various modifications and equivalent ranges of embodiments are possible therefrom. Therefore, the true technical protection scope of the present invention should be determined by the following claims.

1: A block-based method for real event object exchange, the method comprising:
inputting a character twin obtained by digitally imaging a real event object;
generating a virtual block set matching the character twin, the block set being divided into a plurality of regions, and each of the regions corresponding to each of a plurality of character blocks; and
exchanging the character twin for the real event object, when an end condition relating to collection of the character blocks is met.

2: The method of claim 1, wherein the end condition is achieved when the respective character blocks are all filled in the respective regions of the block set; and
when the end condition is met, the real event object is provided to a consumer who has the character twin.

3: The method of claim 1, further comprising:
generating a character twin token in which attribute information on the character twin is encrypted;
generating character block tokens in which attribute information of the plurality of character blocks is encrypted to be distinguished for each region of the block set; and
storing the character twin token and each of the character block tokens in each block of the blockchain.

4: The method of claim 1, wherein the character blocks includes brand character blocks and common character blocks;
the brand character blocks are used for a specific character twin; and
the common character blocks are used for all character twins.

5: The method of claim 1, further comprising:
inputting the character twin obtained by digitally imaging the real event object, by an advertisement event server;
generating the block set for the character twin;
dividing the block set into regions to generate the plurality of character blocks;
inputting registration information of the plurality of character blocks to the advertisement event server;
generating a character block token corresponding to each character block, by the advertisement event server;
recording the character block token in each block of the blockchain;
when attribute information of the character block is input from a consumer terminal, initiating an advertisement event in which the character block is virtually attached to the block set, by the advertisement event server;
generating a character twin token corresponding to the character twin, by the advertisement event server;
recording the character twin token in each block of the blockchain; and
when an end condition of the advertisement event is met, notifying an event progress result to a consumer terminal of a consumer who is selected to be exchanged for the real event object corresponding to the character twin by participating in the advertising event.

6: The method of claim 1, further comprising:
logging in to an advertisement event server, by an advertiser supplying the real event object;
generating the character twin by inputting a digital image of the real event object;
generating the character block corresponding to the character twin; and
inputting registration information of the character block together when generating the character block,
wherein the registration information includes at least one of an advertiser name, an advertisement event period, the number of real event objects, the number of regions of the block set, the number of brand character blocks, the number of common character blocks, advertisement location information of the character block, mission contents information, and mission presence/absence information;
the advertisement location information includes GPS information on a map where the brand character blocks are capable of being found;
the mission contents information includes mission contents capable of being performed in the advertisement location information to find the brand character blocks; and
the mission presence/absence information includes information indicating whether there is the mission contents information or not.

7: The method of claim 1, further comprising:
receiving registration information of the character block,
generating a character block token corresponding to the character blocks in a one-to-one manner;
recording the generated character block token, including at least one of an advertisement ID, a first advertiser electronic wallet address, a number of the character block, and owner information of the character block, in each block of the blockchain;
when a consumer collects the character blocks, recording an address of a second consumer electronic wallet, an address of each block of the blockchain storing the generated character block token, and a hash value of the address of each block of the blockchain, in each block of the blockchain; and
storing the generated character block token, the address of the second consumer electronic wallet, and the address of each block of the blockchain storing the generated character block token, in a third storage unit of the advertisement event server.

8: The method of claim 1, further comprising:
generating character twin tokens, corresponding to the character twins in a one-to-one manner, in which attribute information on the character twins is encrypted;
recording the generated character twin token, including at least one of a token ID, an address of a first advertiser electronic wallet, an advertisement ID, an address of a safe smart contract storing a public key of a magic key, and owner information of the character twin token, in each block of the blockchain;
when a consumer collects all of the plurality of character blocks, recording an address of the second consumer electronic wallet, a private key of the magic key capable of opening the public key of the magic key, and an address of each block of the blockchain storing the generated character twin token and a hash value of the address of each block of the blockchain, in each block of the blockchain; and
storing the generated character twin token, the address of the second consumer electronic wallet, and the address of each block of the blockchain storing the character twin token in a third storage unit of the advertisement event server.

9: The method of claim 1, further comprising:
when the end condition is met, requesting the event processing unit of the advertisement event server to end the advertisement event according to the execution of a character twin token ownership transfer smart contract stored in the blockchain node;
by the event processing unit, ending the advertisement event;
by the event processing unit, selecting a compensation target consumer from among consumers who have collected the plurality of character blocks and notifying him/her of the compensation;
transmitting a guide link of a compensation payment service server including a compensation access token from the advertiser to a second electronic wallet in a consumer terminal of the compensation target consumer;
by the consumer terminal, connecting to the compensation payment service server through the guidance link; and
by the consumer terminal, presenting an address of the second consumer electronic wallet and a compensation access token to the character twin token ownership transfer smart contracts of the compensation payment service,
wherein the character twin token ownership transfer smart contract stored in the compensation payment service verifies the compensation access token presented by the consumer and changes ownership of the character twin stored in the blockchain node from the advertiser to the compensation target consumer.

10: The method of claim 1, further comprising:
when the end condition for the collection of the character blocks is met, changing owner information of a character twin token in the character twin token from an advertiser to a consumer;
when the end conditions are achieved, encrypting a real event object request message with a private key of a magic key, encrypting the same with a private key of a second electronic wallet, and transmitting the same to a blockchain node;
by the blockchain node, executing a safe smart contract to decrypt the real event object request message with a public key of the second electronic wallet and decrypting the same with a public key of the magic key to confirm whether an owner of the character twin token and an owner of the magic key are the same; and
when the owner of the character twin token and the owner of the magic key are the same, transferring ownership of securities capable of being exchanged for the real event object to an address of the second electronic wallet.

11: The method of claim 1, further comprising:
by a consumer terminal, connecting and logging in to an advertisement event server;
inputting a digital code including a QR code, a DataMatrix code, and a barcode, which is input from a camera of the consumer terminal, and inputting advertisement location information input from a GPS receiver of the consumer terminal;
transmitting first attribute information of a brand character block including a number of the brand character block input from the digital code and the advertisement location information to an event processing unit of the advertisement event server;
by the event processing unit of the advertisement event server, confirming whether the received first attribute information of the brand character block is stored in a third storage unit of the advertisement event server;
when the first attribute information of the brand character block is stored in the third storage unit of the advertisement event server, recording the attribute information of the brand character block and an address of the second consumer electronic wallet in each block of the blockchain; and
sequentially repeating steps after inputting the first attribute information of the brand character block until all of the plurality of brand character blocks are found.

12: The method of claim 1, further comprising:
connecting and logging in to an advertisement event server from the consumer terminal;
inputting a digital code including QR code, DataMatrix code, and barcode from a camera of the consumer terminal, and inputting an advertisement location information input from a GPS receiver of the consumer terminal, and mission presence/absence information indicating whether there is the mission contents information requested to the consumer in the advertisement location information;
transmitting second attribute information of a brand character block, including a number of the brand character block input from the digital code, the advertisement location information, and the mission presence information, to an event processing unit of the advertisement event server;
checking, by the event processing unit of the advertisement event server, whether the received second attribute information of the brand character block is stored in a third storage unit of the advertisement event server;
when the second attribute information of the brand character block is stored in the third storage unit of the advertisement event server, recording the second attribute information of the brand character block and an address of the second consumer electronic wallet in each block of the blockchain; and
sequentially repeating steps after inputting the attribute information of the brand character block until all of the plurality of brand character blocks are found.

13: The method of claim 11, further comprising:
when the received character block number is recorded in the blockchain chain block and then the digital code having the same number as the character block number is input from the camera of the consumer terminal, displaying a number of the character block and the advertisement location information in an active window, over the digital code input from the camera of the consumer terminal.

14: The method of claim 1, wherein an advertiser who supplies m real event objects pays an amount of the m real event objects and a reward amount to consumers who have the character twin by collecting the plurality of character blocks, m being a natural number greater than or equal to 2, the end condition being met at the end time set by the advertiser;
pays an amount obtained by dividing the amount of the real event objects and the reward amount by the number of consumers who have the character twin to each of the first to the m-th consumers among consumers who have the character twin until the end time; and
pays an amount obtained by dividing the reward amount by the number of consumers who have the character twin to consumers after the m+1-th consumer among consumers who have the character twin until the end time.

15: The method of claim 1, further comprising:
inputting the real event object corresponding to the character twin in a one-to-one manner from an advertiser terminal to an advertisement event server; and
generating, by a character block generation unit of the advertisement event server, a first character block, a n-th character block, a first region to which the first character block is mapped, and an n-th region to which the n-th character block is mapped, n being natural number greater than or equal to 2,
wherein when the first character block is attached to the first region, the character twin is in a first state; when the n-th block is attached to the n-th region, the character twin is in a second state; and when the character twin 110 is in the second state, the event ends.

16: The method of claim 12, further comprising:
when the received character block number is recorded in the blockchain chain block and then the digital code having the same number as the character block number is input from the camera of the consumer terminal, displaying a number of the character block and the advertisement location information in an active window, over the digital code input from the camera of the consumer terminal.
